(19) United States
(12) Patent Application Publication
(10) Pub. No.: US 2014/0322115 A1
(43) Pub. Date: Oct. 30, 2014

(54) Method and an Apparatus for the Absorption of Carbon Dioxide

(71) Applicant: Sulzer Chemtech AG, Winterthur (CH)

(72) Inventor: Markus Duss, Winterthur (CH)

(21) Appl. No.: 14/359,861

(22) PCT Filed: Oct. 11, 2012
(86) PCT No.: PCT/EP2012/070138

§ 371 Date: May 21, 2014

(30) Foreign Application Priority Data
Nov. 29, 2011 (EP) 11191171.5

(51) Int. Cl. B01D 53/62

(52) U.S. Cl. CPC B01D 53/62
USPC 423/228; 422/222; 423/220

(57) ABSTRACT

The invention relates to a method of performing a carbon dioxide absorption with reduced risk of aerosol formation from a carbon dioxide containing stream in an absorption apparatus having a specific sequence of sections and wherein the method comprises specific steps. Another aspect of the invention relates to a use of a structured packing as part of a carbon dioxide absorption section in an apparatus for the absorption of carbon dioxide, characterized in that the use is in reducing the risk of aerosol formation in a top region of the carbon dioxide-absorption section. Yet another aspect of the invention is a use of an absorption apparatus comprising a specific sequence of sections, wherein the use is for avoiding a super-saturation of a solvent and water and a risk of aerosol formation.

The present invention relates to a method and an apparatus for the absorption of carbon dioxide. The invention belongs in particular to the field of CCS (Carbon Capture and Sequestration) and more specifically to post-combustion processes where absorption technology is used for capturing carbon dioxide from the flue gas for reduction of carbon dioxide emissions.

A conventional apparatus for the absorption of carbon dioxide is for instance disclosed in US20030045756. The absorption apparatus is a column, for which the term absorption tower is used. This absorption tower contains a carbon dioxide absorption section and a combined wash and cooling section. In the carbon dioxide absorption section of the absorption tower, the fed combustion exhaust gas or flue gas is brought into counter current contact with an absorbing solution, which is a solvent for carbon dioxide. This solvent is an aqueous solution of an amine, an amine acid or in general a compound which reacts with carbon dioxide and which has a relevant vapour pressure. The carbon dioxide comes into contact with the absorbing solution and a chemical reaction between the carbon dioxide and the reacting solvent takes place. Thereby the absorbing solution is loaded with the carbon dioxide which has chemically reacted with the reacting solvent compound, thus the absorbing solution has absorbed the carbon dioxide from the exhaust gas. The chemical reaction is exothermic, thus the temperature of the absorbing solution rises during the absorption process.

When contacting the carbon dioxide containing flue gas with the solvent, the flue gas will be saturated with solvent according to partial pressure of the solvent. The partial pressure and therefore the saturation concentration of the solvent in the flue gas increases with increasing temperature. The decarbonated exhaust gas leaving the absorption section contains therefore a solvent concentration which is relatively high and cannot be emitted to the atmosphere. For this reason, a combined wash and cooling section is provided in the absorption tower. The combined wash and cooling section is used to remove the evaporated amine compound from the decarbonated exhaust gas and to condense water. According to a solution disclosed in US2003/0045756 A1, the wash water is pumped from a liquid reservoir in the absorption tower to a cooler and fed back to the top of the packing section above the liquid reservoir. Such a section configuration is also referred to as pump around in the literature. Means to distribute the water evenly over the tower diameter are provided. Further means are provided for contacting the decarbonated exhaust gas containing evaporated amine compound for removing the amine compound from the decarbonated exhaust gas into the wash water. The document US2003/0045756 A1 teaches that a single combined wash and cooling section has not been sufficient to remove the amine compound from the decarbonated gas stream entirely. The solution proposed in this document is to foresee a plurality of combined wash and cooling sections in a plurality of stages in the absorption tower.

A further method for decreasing the solvent content in the decarbonated exhaust gas stream is disclosed in WO2011/087972. According to the method disclosed in this document, a control unit is provided, which regulates a water stream substantially free of the solvent brought into counter-current contact with the flue gas in an emission control section which is a wash section and the amount of cooled wash water recycled to the gas cooling section of the absorption apparatus. Thereby the amount of solvent leaving the absorption apparatus together with the cooled decarbonated gas stream is minimized. Thus, the column for performing the method according to WO2011/087972 contains an absorption section, a wash section arranged above the absorption section and a cooling section arranged above the absorption section.

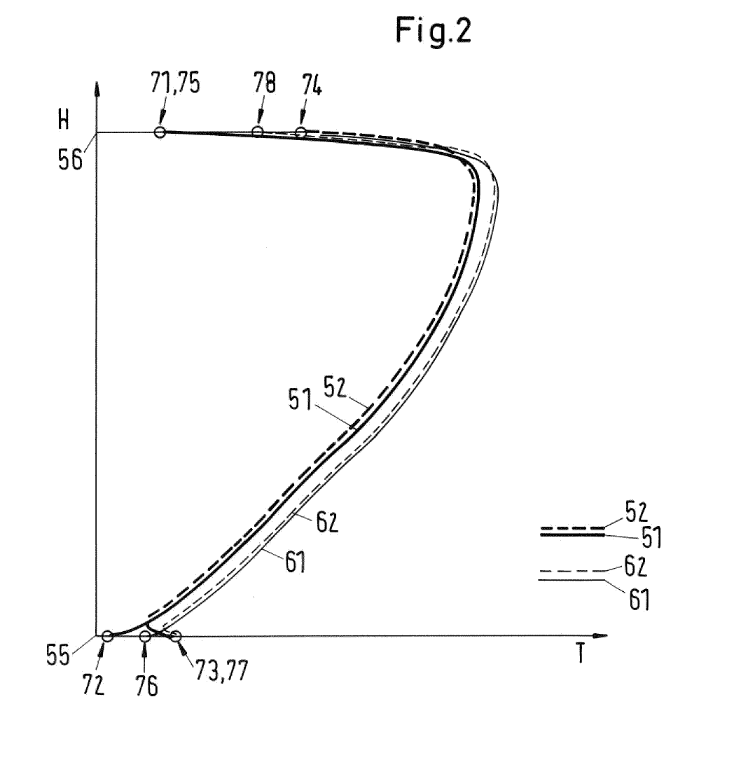

However, an additional problem is associated with the absorption of carbon dioxide by the solvent, which is inherent with the absorption reaction taking place in the absorption section. The absorption reaction of the carbon dioxide with the amine compounds is exothermic, thus the temperature of the gas containing carbon dioxide increases when it passes the absorption section. At the top end portion of the absorption section the gas is contacted with the cooled lean solvent and thus the gas temperature drops sharply. FIG. 2 shows a typical temperature profile of the absorption section. Due to the fast cooling of the flue gas at the top end portion of the absorption section, it becomes super-saturated with the solvent and water and the risk of aerosol formation becomes latent. Super-saturation cannot be avoided due to different heat and mass flux rates which is a characteristic of the provided packing in the section and will be explained later.

In the top of the absorption section, thus the upper end portion of the packing element, the temperature change is fast due to the high flux of sensible heat, which is due to the difference in temperature. The mass flux, in particular of the solvent, is not fast enough to remain below the equilibrium saturation according to the partial pressure when the flue gas temperature drops fast. The concentration of the solvent and water become higher than the saturation concentration, which is referred to as the condition of super-saturation.

The higher the temperature drop of the decarbonated gas at the upper end portion of the packing element of the absorption section, the higher is the degree of super-saturation. An increasing degree of super-saturation increases the likelihood of aerosol formation. Aerosols form when the super-saturated component present in the gas-phase forms droplets, i.e. is condensed in the bulk of the gas phase. The formation of droplets is caused by nucleation. If solid particles are present in the gas stream, the probability of nucleation increases with increasing concentration of such solid particles in the gas stream. Flue gas streams habitually contain fly ash and possibly sulfite or sulphate particles which can serve as nucleation starters and are carried with the flue gas stream from a flue gas desulphurization unit arranged upstream of the carbon dioxide absorption apparatus.

The aerosol droplets are in the range of less than 5 μm, mostly less than 2 μm. Droplets of such a small size can not be captured by a conventional droplet separator, thus it is not possible to filter the aerosols by conventional droplet separation equipment, which has the consequence that an undesired amount of aerosols remains in the purified gas stream leaving the absorption apparatus at the top thereof.

It is therefore the object of the present invention to propose an improved absorption method and an improved absorption apparatus for performing said improved absorption method for the absorption of carbon dioxide from a carbon dioxide containing gas stream. In particular it is an object of the invention to reduce the risk of formation of aerosol.

For the following description of the invention, the following definitions are considered to be helpful:

Absorption section: The purpose of the absorption section is to remove carbon dioxide from the flue gas. Carbon dioxide is absorbed from a flue gas using a solvent which reacts with carbon dioxide.

Wash section: The purpose of the wash section is to absorb solvent. Cooling of the flue gas is not the task of the wash section. The solvent is removed from a low carbon dioxide containing flue gas, using substantially solvent free water. The water is not recycled from the bottom of this section to the top: the wash section is operated in a “once through” mode. The water used in the wash section to absorb the solvent from the flue gas is the condensate branched from the cooling section plus optionally water make-up, if available.

Gas cooling section: The purpose of the gas cooling section is to condense water. The gas cooling section is not specifically designed to absorb solvent. The gas cooling section is operated with cooled water as cooling fluid, which possibly contains traces of solvent and the flue gas is cooled, thereby condensing water to minimize the required water make-up. The gas cooling section is operated as “pump-around”, i.e. the cooling fluid is collected in a collector below the gas cooling section, is withdrawn and recycled to a heat exchanger to cool the fluid to the required temperature. A fixed cooling fluid rate is then fed to the top of the gas cooling section. A part of the withdrawn cooling fluid is branched and used in the wash section. The amount of branched cooling fluid is the same as the amount of condensate formed in the cooling section.

Combined wash and cooling section: The purpose of the combined wash and cooling section is to condense water and to remove solvent. This section is operated with cooling fluid which contains mainly water and solvent. Make-up water, if available, might be fed to this section. The flue gas is cooled and water is condensed to minimize the required water make-up. A considerable part of the solvent is also absorbed and therefore the condensed water contains solvent. The combined wash and cooling section is operated as “pump-around”, i.e. the cooling fluid is collected in a collector below the combined wash and cooling section, is withdrawn and recycled to a heat exchanger to cool the fluid to the required temperature. A fixed cooling fluid rate is then recycled to the top of the combined wash and cooling section. A part of the withdrawn cooling fluid is branched and can be fed either to the carbon dioxide section or to a second combined wash and cooling section or to a wash section. The amount of branched cooling fluid is the same as the amount of condensate formed in the cooling section.

### SUMMARY OF THE INVENTION

The invention relates to an apparatus and a method for performing carbon dioxide absorption with reduced risk of aerosol formation by the use of selective mass transfer equipment for the carbon dioxide-absorption section(s) and using a specific absorber configuration.

One aspect of the invention relates to a method of performing a carbon dioxide absorption from a carbon dioxide containing stream in an absorption apparatus with reduced risk of aerosol formation, wherein the absorption apparatus comprises the following sections in sequence listed from bottom to top of a vessel of the apparatus:
at least one carbon dioxide absorption section
a “once through” wash section
a cooling section

wherein no liquid separator is located between the carbon dioxide absorption section and the wash section,

and wherein the method comprises the steps of:

(i) passing the carbon dioxide containing gas stream through a carbon dioxide absorption section to form a purified gas stream containing solvent and reduced in carbon dioxide content by means of absorbing the carbon dioxide using a solvent,

(ii) passing the purified gas stream through a “once through” wash section, which is operated with water condensate from a cooling section above the “once through” wash section and optionally with make-up water, to form a purified and washed gas stream having a reduced solvent content,

(iii) feeding the purified and washed gas stream into a cooling section to cool the purified and washed gas stream and to condense water to form a water condensate,

(iv) withdrawing the water condensate from the cooling section,

(v) recirculating (pumping around) a part of the withdrawn water condensate back into the cooling section,

(vi) feeding a remaining part of the withdrawn water condensate to the wash section, and wherein either all of or only a recirculated part of the water condensate withdrawn from the cooling section in step (iv) is cooled.

In a preferred embodiment of the method of the invention, no liquid collector is located between the carbon dioxide absorption section and the wash section. In another preferred embodiment of the method, a cooled, purified, and washed gas stream produced by the method contains aerosol droplets, wherein the aerosol droplets are virtually free of solvent and consist mainly of water.

In yet another preferred embodiment of the method, the carbon dioxide-absorption section has a selective mass transfer equipment characterised by a poor vapour side heat and mass transfer. In a specifically preferred embodiment, the mass transfer equipment characterised by a poor vapour side heat and mass transfer is a structured packing selected from:

(a) a structured packing consisting of corrugated sheets having a corrugation angle of less than 30 degrees from the column axis, preferably less than 25 degrees, or

(b) a structured packing having a first layer having first corrugations, a second layer having second corrugations, a plurality of open channels formed by the first corrugations and the second corrugations, wherein the channels include a first corrugation valley, a first corrugation peak and a second corrugation peak, wherein the first corrugation peak and the second corrugation peak bound the first corrugation valley, wherein the first and the second corrugation peaks have a first apex and a second apex, wherein a protrusion or an indentation extends in the direction of the first apex, wherein if a protrusion is provided the normal spacing of at least one point of the protrusion from the valley bottom of the corrugation valley is larger than the normal spacing of the first apex from the first valley bottom of the corrugation peak, and wherein if an indentation is provided the normal spacing of at least one point of the indentation from the valley bottom of the corrugation valley is smaller than the normal spacing of the first apex from the first valley bottom of the corrugation peak.

In still another preferred embodiment of the method, the solvent is an aqueous solution of an amine, an amine acid or a volatile compound which reacts with carbon dioxide.

Another aspect of the invention is a use of a structured packing as part of a carbon dioxide absorption section in an apparatus for the absorption of carbon dioxide, wherein the structured packing is selected from:

(a) a structured packing consisting of corrugated sheets having a corrugation angle of less than 30 degrees from the column axis, preferably less than 25 degrees, or

(b) a structured packing having a first layer having first corrugations, a second layer having second corrugations, a plurality of open channels formed by the first corrugations and the second corrugations, wherein the channels include a first corrugation valley, a first corrugation peak and a second corrugation peak, wherein the first corrugation peak and the second corrugation peak bound the first corrugation valley, wherein the first and the second corrugation peaks have a first apex and a second apex, wherein a protrusion or an indentation extends in the direction of the first apex, wherein if a protrusion is provided the normal spacing of at least one point of the protrusion from the valley bottom of the corrugation valley is larger than the normal spacing of the first apex from the first valley bottom of the corrugation peak, and wherein if an indentation is provided the normal spacing of at least one point of the indentation from the valley bottom of the corrugation valley is smaller than the normal spacing of the first apex from the first valley bottom of the corrugation peak, characterized in that the use is in reducing the risk of aerosol formation in a top region of the carbon dioxide-absorption section.

In a preferred embodiment of the use of the structures packing, the use is additionally in increasing a maximum carbon dioxide loading in a bottom region of the carbon dioxide absorption section.

Still another aspect of the invention is a use of an absorption apparatus comprising the following sections in sequence listed from bottom to top of a vessel of the apparatus:
at least one carbon dioxide absorption section
a wash section
a cooling section
   characterized in that no liquid separator is located between the carbon dioxide absorption section and the wash section, and wherein the use is for avoiding a super-saturation of a solvent and water and a risk of aerosol formation.

In a preferred embodiment of the use of the absorption apparatus, the carbon dioxide-absorption section has a selective mass transfer equipment characterised by a poor vapour side heat and mass transfer. In a specifically preferred embodiment, the mass transfer equipment characterised by a poor vapour side heat and mass transfer is a structured packing, wherein the structured packing is selected from:

(a) a structured packing consisting of corrugated sheets having a corrugation angle of less than 30 degrees from the column axis, preferably less than 25 degrees, or

(b) a structured packing having a first layer having first corrugations, a second layer having second corrugations, a plurality of open channels formed by the first corrugations and the second corrugations, wherein the channels include a first corrugation valley, a first corrugation peak and a second corrugation peak, wherein the first corrugation peak and the second corrugation peak bound the first corrugation valley, wherein the first and the second corrugation peaks have a first apex and a second apex, wherein a protrusion or an indentation extends in the direction of the first apex, wherein if a protrusion is provided the normal spacing of at least one point of the protrusion from the valley bottom of the corrugation valley is larger than the normal spacing of the first apex from the first valley bottom of the corrugation peak, and wherein if an indentation is provided the normal spacing of at least one point of the indentation from the valley bottom of the corrugation valley is smaller than the normal spacing of the first apex from the first valley bottom of the corrugation peak.

### DETAILED DESCRIPTION OF THE INVENTION

The absorption apparatus for the absorption carbon dioxide from a carbon dioxide containing gas stream includes a vessel comprising an absorption section containing a packing element arranged between a bottom end of the vessel and a top end of the vessel, the vessel having a main axis extending from the bottom end of the vessel to the top end of the vessel and an inlet for feeding the carbon dioxide containing gas stream to the vessel at the bottom end and an outlet for discharging a purified gas stream at the top end, a solvent inlet for adding a lean solvent above the packing element and a solvent outlet for discharging rich solvent from the vessel at a location below the packing element. The packing element is disposed with a plurality of layers which are constituted as sheets wherein at least some of the sheets have corrugations and the corrugations having corrugation peaks forming crests and corrugation valleys forming troughs and the respective crests or troughs of the corrugations including an angle with the main axis of the absorption apparatus which is less than 30 degrees at least over a portion of the height of the packing sheet. Preferably the angle of the corrugations with the main axis of the absorption apparatus is not more than 25 degrees, particularly preferred not more than 20 degrees at least over a portion of the height of the packing sheet. The portion of the height is preferably at least 5% of the height of the packing sheet, more preferably at least 10% of the height of the packing sheet, most preferred at least 15% of the height of the packing sheet. The portion is arranged at the top end of the sheet or in the vicinity of the top end due to the pronounced temperature difference in the vicinity of the top end of the packing sheet.

The plurality of layers can include at least a first layer and a second layer, wherein the first layer is a first sheet having a first corrugation and the first corrugation includes an angle of corrugation greater than 0 degrees with the main axis and the second layer being arranged cross wise to the first layer.

According to an embodiment, the absorption apparatus has a packing element comprising a first section and a second section, the first section being arranged beneath the second section and each of the first and second sections containing a plurality of layers and the first section containing a plurality of first section layers having a first angle of corrugation and the second section containing a plurality of second section layers having a second angle of corrugation and the first angle of corrugation differing from the second angle of corrugation. Advantageously, in this case the first angle of corrugation is greater than the second angle of corrugation.

The plurality of layers advantageously includes at least a first layer and a second layer, whereas the first layer is a first sheet having a first corrugation and the first corrugation includes an angle of corrugation of 0 degrees with the main axis and wherein the second layer includes an angle of 0 degrees with the main axis and/or at least one of the first or second layers contains a plurality of protrusions.

The solvent in use according to any of the embodiments of the absorption apparatus is at least one of an aqueous solvent or a solvent containing a volatile compound.

An absorption apparatus according to an embodiment comprises a wash section which is arranged in the vessel between the top end and the absorption section. The wash section on top of the absorption section contains in this case a packing element and a water/liquid inlet is arranged on top of the packing element and a distributor element is arranged between the inlet and the packing element. Furthermore a cooling section can be arranged between the wash section and the top end.

According to an embodiment, the absorption apparatus for the absorption of carbon dioxide from a carbon dioxide containing gas stream includes a vessel comprising an absorption section containing a packing element arranged between a bottom end of the vessel and a top end of the vessel, the vessel having a main axis extending from the bottom end of the vessel to the top end of the vessel and an inlet for feeding the carbon dioxide containing gas stream to the vessel at the bottom end and an outlet for discharging a purified gas stream at the top end, a solvent inlet for adding a lean solvent above the packing element and a solvent outlet for discharging rich solvent from the vessel at a location below the packing element. The packing element is disposed with a plurality of layers which are constituted as sheets wherein at least some of the sheets have corrugations and the corrugations having corrugation peaks forming crests and corrugation valleys forming troughs and the respective crests or troughs of the corrugations including an angle with the main axis of the absorption apparatus which is not more than 50 degrees over at least a portion of the height of the packing sheet and at least each second one of the packing layers having at least one of an indentation or a protrusion. According to an advantageous variant, the angle of corrugation is constant. Preferably the angle of the corrugations with the main axis of the absorption apparatus is not more than 30 degrees, particularly preferred not more than 25 degrees at least over a portion of the height of the packing sheet. The portion of the height is preferably at least 5% of the height of the packing sheet, more preferably at least 10% of the height of the packing sheet, most preferred at least 15% of the height of the packing sheet. The portion is arranged at the top end of the sheet or in the vicinity of the top end due to the pronounced temperature difference in the vicinity of the top end of the packing sheet.

Furthermore the invention is concerned with a method for the absorption of carbon dioxide from a carbon dioxide containing gas stream in an absorption apparatus, said absorption apparatus including a vessel, comprising an absorption section containing a packing element arranged between a bottom end of the vessel and a top end of the vessel, the vessel having a main axis extending from the bottom end of the vessel to the top end of the vessel and an inlet for feeding the carbon dioxide containing gas stream to the vessel at the bottom end and an outlet for discharging a purified gas stream at the top end, a solvent inlet for adding a lean solvent above the packing element and a solvent outlet for discharging rich solvent from the vessel at a location below the packing element, comprising the steps of feeding the carbon dioxide containing gas stream to the inlet at the bottom end, feeding a lean solvent on top of the packing element and distributing the lean solvent onto the packing element, absorbing the carbon dioxide from the carbon dioxide containing gas stream in the absorption section into the solvent, discharging a gas stream of low carbon dioxide content from the absorption section, wherein the packing element is disposed with a plurality of layers, which are constituted of sheets wherein at least some of the sheets have corrugations, the corrugations having corrugation peaks forming crests and corrugation valleys forming troughs and the respective crests or troughs of the corrugations including an angle with the main axis of the absorption apparatus which is less than 30 degrees over at least a portion of the height of the packing sheet or including an angle with the main axis of the absorption apparatus which allows for a lower interstitial gas velocity as compared to the bulk gas velocity of the carbon dioxide containing gas stream entering the packing element or the gas stream of low carbon dioxide content leaving the packing element. The portion of the height is preferably at least 5% of the height of the packing sheet, more preferably at least 10% of the height of the packing sheet, most preferred at least 15% of the height of the packing sheet. The portion is arranged at the top end of the sheet or in the vicinity of the top end due to the pronounced temperature difference in the vicinity of the top end of the packing sheet.

According to an advantageous configuration of the absorption apparatus the gas stream of low carbon dioxide content is cleaned from solvent entrained with the gas stream of low carbon dioxide content in a wash section, wherein the wash section contains a packing element and wherein a wash liquid, in particular water is fed into the vessel on top of the packing element and the wash liquid is distributed onto the packing element, wherein the wash liquid proceeds in counter current flow to the gas stream of low carbon dioxide content and the solvent contained in the gas stream of low carbon dioxide content is absorbed into the wash liquid during the passage through the packing element and a purified washed gas leaves the wash section.

The wash section can be followed by a cooling section, the cooling section being arranged above the wash section and cooling of the purified washed gas is performed by directing the purified washed gas over a packing element and a cooling fluid passing in counter current flow to the purified washed gas so that the purified washed gas is cooled before leaving the absorption apparatus.

The cooling fluid is advantageously substantially guided in a closed cycle and the part of the liquid which is condensed is branched and fed into the wash section. The cooling fluid fed to the wash section forms the wash liquid, which is charged with solvent in the wash section, which is recycled to the absorption section.

Thus, the mass transfer equipment used in the carbon dioxide-absorption section(s) is chosen to optimize carbon dioxide absorption to reduce pressure drop and to reduce the degree of super-saturation, which is achieved by mass transfer equipment characterised by a poor vapour side heat and mass transfer, which will be also referred to as ‘selective’ packing. The mass transfer equipment with poor vapour side heat and mass transfer properties but still good liquid side mass transfer properties shows the following two benefits of (a) a reduced risk of aerosol formation in the top of the carbon dioxide-absorption section and (b) an increased maximum carbon dioxide loading in the bottom of the carbon dioxide absorption section.

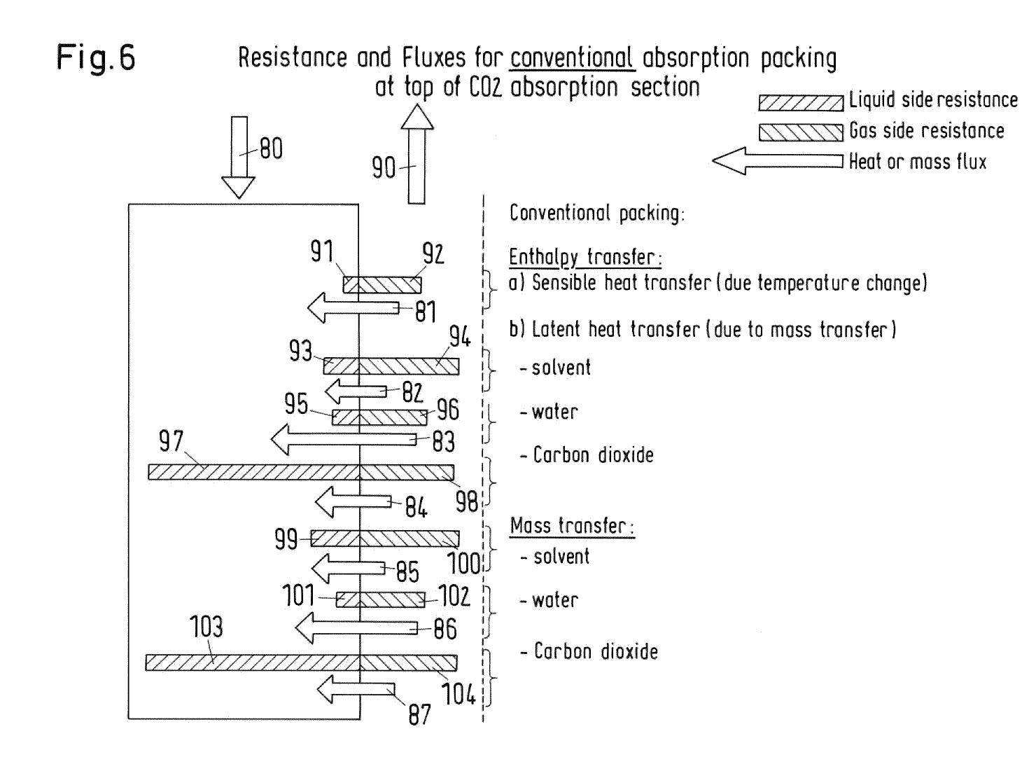

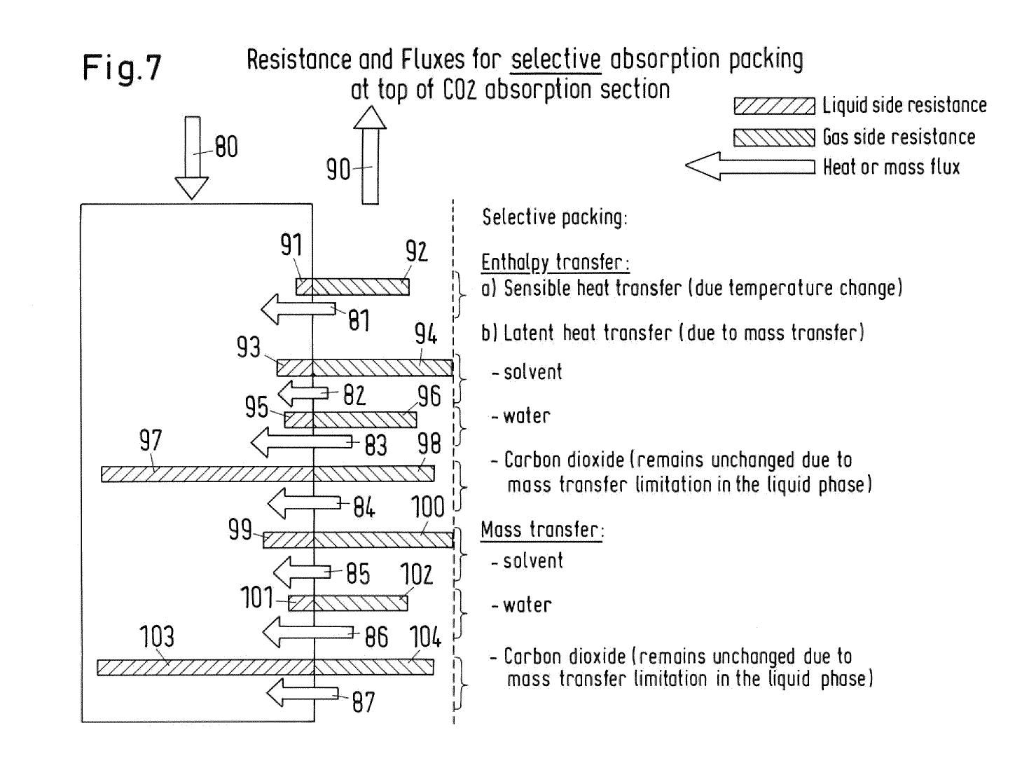

FIG. 6 shows the mass transfer and the enthalpy transfer between the gas and the liquid in a schematic representation for a conventional packing element, FIG. 7 for a selective packing element according to the invention. In general a mass transfer or enthalpy transfer implies that a heat or a component moves from a gas phase to a liquid phase or vice versa, thus it can be attributed a flow rate or a heat flux. In the course of this movement, the heat or the component encounters resistances traversing from the bulk of the phase to the boundary between gas and liquid phase. The flux and the resistance due to enthalpy transfer and mass transfer is shown in FIG. 6 and FIG. 7, which allows to compare the respective quantities for the conventional packing element according to FIG. 6 and the selective packing according to FIG. 7. The magnitude of the respective flux is thereby roughly proportional to the length of the respective arrow. The corresponding fluxes in FIG. 6 and FIG. 7 carry the same reference numbers. Thus FIG. 6 and FIG. 7 show the heat flux due to sensible heat transfer 81, the heat flux due to latent heat transfer, thus mass transfer of the solvent 82, the heat flux due to latent heat transfer for water 83, the heat flux due to latent heat transfer of carbon dioxide 84, the mass transfer flux for solvent 85, the mass transfer flux for water 86 and the mass transfer flux for carbon dioxide 87. Furthermore FIG. 6 and FIG. 7 show the resistances on the liquid side represented by liquid side flow 80 and on the gas side represented by gas side flow 90 for sensible heat transfer 91, 92, for latent heat transfer for solvent 93, 94, for latent heat transfer for water 95, 96, for latent heat transfer for carbon dioxide 97, 98, the mass transfer of solvent 99, 100, the mass transfer of water 101, 102, the mass transfer of carbon dioxide 103, 104.

FIG. 7 shows that all fluxes are reduced as compared to the prior art except for the flux of carbon dioxide. The fluxes for carbon dioxide must be the same in FIG. 6 and FIG. 7, since these are liquid side controlled. The resistance in the gas phase is increased for enthalpy transfer as well as mass transfer for the selective packing. This has the consequence that the amount of water and solvent which is transported into the liquid phase will be reduced as the respective gas side resistances are higher than for the conventional packing and thus the latent heat transfer for solvent and water as well as the mass transfer of water and solvent is lower in the gas phase of ‘selective packing’. In other words, it is the gas side resistance 94, 96 and 100, 102 which limits the flux to the liquid phase. Only for carbon dioxide the resistance in the liquid phase is higher than in the gas phase, thus for the mass and energy transfer for carbon dioxide there is no difference between the conventional packing element and the packing element according to the invention.

Thus the use of a selective packing is not creating any disadvantages for the primary objective, namely the carbon dioxide absorption. However the increase of the gas side resistances for latent heat transfer and mass transfer has the result, that the solvent and water flux will be lowered. That means that the temperature of the gas phase will higher, leaving at the top.

The increased resistance to sensible heat transfer has the consequence that the temperature profile according to FIG. 2 is shifted to higher temperatures which is beneficial for the purpose of avoiding super-saturation.

The purified gas stream leaving the carbon dioxide absorption section has a higher enthalpy due to the reduced vapour side heat and mass transfer, when using a selective packing. The enthalpy mentioned is the specific energy contained in the purified gas stream in this example. The enthalpy of the leaving flue gas stream is higher due to the increased temperature, also commonly referred to as sensible heat, as compared to a gas stream leaving a conventional heat and mass transfer equipment used in carbon dioxide-absorption. Not only the temperature of the leaving purified gas is higher but also the water and solvent content in the purified gas is increased and thus the enthalpy is further increased. Enthalpy change due to concentration change, thus mass transfer, is commonly referred to as change in latent heat. The increase in temperature also referred to sensible heat, and increase in the water concentration, thus, the latent heat results in a significantly higher gas enthalpy of the gas stream leaving the carbon dioxide absorption section at the very top. Due to the higher flue gas temperature leaving the carbon dioxide section at the top, the degree of super-saturation is reduced and therefore the risk of aerosol formation is reduced.

Since the enthalpy is increased in the leaving purified gas stream, the liquid leaving at the very bottom of the carbon dioxide-absorption section has a lower enthalpy and therefore the resulting liquid temperature is lower according to the enthalpy balance. The lowered liquid temperature at the bottom is beneficial, because it is a typical characteristic of CCS absorbers, that these units are designed to be ‘rich end pinched’ operated. This means that the solvent will be loaded as high as possible with carbon dioxide, so that thermodynamic equilibrium is approached.

Thermodynamic equilibrium is nearly reached close to the very bottom of the carbon dioxide absorption section. When the temperature is lowered, the thermodynamic equilibrium is shifted to higher carbon dioxide loadings, thus the amount of possible carbon dioxide absorption is increased with a given solvent flow rate.

The reason why poor gas side mass transfer results in an increased temperature of the gas leaving the carbon dioxide absorption section is as follows: the rate also referred to a flux of enthalpy transfer thus the sum of the sensible heat corresponding to temperature change and the latent heat—corresponding to concentration change—is predominantly vapour side controlled, whereas the rate of carbon dioxide absorption is liquid side controlled. Therefore, maintaining the liquid side mass transfer rate and reducing the vapour side heat and mass transfer rate results in the explained behaviour: The risk of aerosol formation in the carbon dioxide absorption section is decreased.

As mentioned above, it is a typical characteristic of post-combustion carbon dioxide absorbers that they are designed ‘rich end pinched’. Due to such a design and due to the gas inlet conditions, the temperature profile in the column increases from the bottom to the top. The temperature increase is predominantly due to the released heat of absorption and heat of reaction. As the lean solvent which is fed to the very top of the carbon dioxide absorbing section has a low temperature which is typically about 30° C. to 45° C., the gas stream is cooled at the top of the carbon dioxide absorbing section, close to the inlet of the lean solvent. This leads to a sharp temperature drop of the gas stream of low carbon dioxide content and a condensation of water and solvent occurs. Sensible heat transfer which is enthalpy transfer due to temperature change is vapour side controlled and conventional packing elements are very efficient. Latent heat transfer due to concentration change is also mainly vapour side controlled, but depending on the transferred component, the vapour side mass transfer can be slower than for sensible heat and is different for each component. This behaviour is illustrated in FIGS. 6 and 7. Particularly components with higher molecular weights, such as solvents typically have, show a reduced flux in mass transfer due to the slower diffusivity. If the sensible heat transfer is faster than the latent heat transfer even though both mainly vapour side controlled, it cannot be avoided that the gas phase becomes super-saturated or sub-cooled. This holds true for solvents having a relevant partial pressure used in carbon dioxide absorbers. Whenever a gas stream is super-saturated, the risk of aerosol formation becomes latent. At which degree of super-saturation aerosols will be formed, cannot be predicted and depends sensitively how nucleation of molecules occurs. But in any case it holds: the less the super-saturation, the less the risk is to form aerosols.

Due to the reduced vapour side heat and mass transfer rate of a selective packing, the temperature drop at the very top of the carbon dioxide absorption section is reduced and therefore also the degree of super-saturation: the risk to form aerosols at the top of the carbon dioxide-absorption section is reduced.

A packing with selectively reduced vapour side mass transfer characteristics is e.g. disclosed in EP2230011 A1, WO2010/106011 A1, WO2010/106119. Therefore, such a packing can be preferably used in the carbon dioxide-absorption section. However, a structured packing consisting of corrugated sheets can be modified to reduce intentionally the vapour side mass transfer by reducing the corrugation angle. A corrugation angle of less than 30 degrees from the column axis, preferably less than 25 degrees, achieves a reduced vapour side heat and mass transfer. Such packing types are not commonly used due to poor mass transfer characteristics in the vapour phase, which is usually a disadvantage. The reason of the reduced vapour side heat and mass transfer rate is the lower interstitial gas velocity obtainable with a packing having a corrugation angle of less than 30 degrees with respect to the column axis. Under interstitial velocity it is intended the gas velocity within the packing. If the packing is of a type having corrugations arranged crosswise, such corrugations form crossing channels. The gas passes along the channels or traverses the channels. The interstitial gas velocity is determined by two effects: (a) void fraction due to the volume occupied by the packing and its liquid hold-up. This has a minor effect in structured packing and is independent on the corrugation angle. (b) The orientation of the gas flow imposed by the corrugation angle. Increasing corrugation angle (relative to column axis) results in increasing interstitial gas velocity.

The gas is guided by the corrugation channels and thus a lower interstitial gas velocity as compared to the conventional packing element is achieved by a reduced corrugation angle. This results in a reduced gas turbulence which reduces the vapour side heat and mass transfer. Whereas a reduced vapour side heat and mass transfer is commonly not in favour, for the purposes of this invention it has a favourable effect.

Random packing elements cannot be easily modified to achieve such a selective behaviour as the interstitial velocity is likely to be independent of the orientation of a single random packing element of the bulk of random packing elements forming the random packing. Trays are not commonly used in such applications due to the high pressure drop inherent to such a solution. Furthermore, vapour side heat and mass transfer cannot be easily influenced by simple geometrical modifications.

An advantage of the invention is the reduction of the degree of super-saturation in the gas stream and thus the risk of aerosol formation, which would cause solvent emission in liquid form. Aerosol formation may result in too high solvent emissions: If aerosols are formed, excessive effort is required to remove them. The invention aims to avoid aerosol formation by using a selective packing to reduce the degree of super-saturation and using a specific absorption apparatus configuration including a selective packing.

A further advantage of the invention is the possibility to increase the carbon dioxide loading in the rich solvent, which allows overall process optimization in terms of energy, thus minimization of the overall energy consumption being the key for all processes in this field of application. This target is reached by using mass transfer equipment with different liquid and gas mass transfer behaviour thus so called selective mass transfer equipment which results in a higher gas enthalpy of the gas stream leaving the carbon dioxide absorption section. Since the enthalpy increase due to the carbon dioxide absorption remains constant and also the enthalpy of all feed streams remain constant, the enthalpy of the liquid stream leaving at the bottom of the carbon dioxide absorption section is reduced, i.e. the resulting bottom liquid temperature is lower.

A further advantage of the invention is to minimize gaseous solvent emissions to atmosphere. So far, solvent emissions were minimized by using a combined wash and cooling section. The combined wash and cooling section consists of a packing element arranged in the absorption column. The carbon dioxide depleted gas stream passes through the packing element in counter current flow to the wash water. The cooled water is circulated or pumped around, thus it is common to use the term pump-around for this operation. A single pump-around does not achieve an extremely low solvent concentration. For this reason, a plurality pump-arounds in series can be used as disclosed in US2003/0045756. For each cooling section the following elements are needed: a draw-off tray, a pump, a heat exchanger, piping and control equipment.

The proposed absorbing apparatus comprises the following sections in a sequence listed from bottom to top of the vessel: at least one carbon dioxide absorption section, a wash section and then a cooling section, a configuration which similar as the one disclosed in WO2011/087972.

The proposed column configuration has the following main benefits, namely low solvent emissions to atmosphere as well as a reduced risk of aerosol formation in the wash section and cooling section. In addition, no liquid separator is required between the carbon dioxide absorption section and the wash section.

After the carbon dioxide containing gas stream, such as a flue gas, has passed through the carbon dioxide absorption section(s), it enters first into a wash section, also referred to as ‘once through’ section, which is operated with water condensate from the cooling section above the wash section and optionally with make-up water, if available. This water feed has a very low solvent concentration and allows therefore a nearly complete removal of the solvent from the gas stream in the wash section. The water stream at the bottom from the wash section is rich in solvent and can be fed to the carbon dioxide-absorption section below.

The purified washed gas stream leaving the wash section has a low solvent concentration and is fed into the cooling section to cool the gas stream and to condense water. This section is required to minimize the need of make-up water. The condensate formed in this section is withdrawn and is used as feed to the wash section. This condensate has a very low solvent concentration.

The proposed configuration of the absorption apparatus allows to perform a method for the absorption of the solvent, with a water feed rate to the wash section, which allows a better efficiency of the mass transfer equipment as compared to prior art, where the wash section is above the cooling section using only make-up water, which is mentioned as prior art in WO2011/087972. The better efficiency is due to the increased water feed rate, improving the wetting behaviour of the packing. The increased water feed rate allows also to absorb the solvent from the gas stream at higher temperatures, without facing thermodynamic restrictions, thus an increased amount of water resulting from the use of condensate. The solvent concentration in the gas stream can nevertheless be reduced to the desired concentration in the wash section as there is an increased amount of water available due to the use of the condensate.

Gas streams can contain liquid which is entrained by the gas from the liquid inside the packing or from the liquid distributor. Such entrained liquid is not due to aerosol formation, which is condensation, but due to frictional forces acting between the vapour and the liquid phase. Such entrained liquid forms relative big droplets with droplets diameter of more than 20 microns. Droplets of such size can be removed by appropriate equipment such as liquid separators.

Due to the proposed configuration of the sections, any such entrained liquid from the carbon dioxide absorption section by the gas is not critical as there would be little impact on the subsequent wash section arranged above and therefore the installation of a liquid separator can be avoided as required in the prior art document US2003/0045756. The reason why a liquid separator is of advantage in the prior art using a combined wash and cooling section is as follows: the packing element acts as droplet separator. Thus, liquid entrained by the gas which is entering the combined wash and cooling section will be separated in the packing element of the combined wash and cooling section and will mix with the cooling fluid. Entrained liquid from the absorption section contains a high solvent concentration and thus the concentration in the cooling liquid will be increased. Since the cooling liquid will be recycled to the top of the combined wash and cooling section, the high solvent concentration is a disadvantage and the section cannot remove anymore the solvent from the decarbonated gas as effectively, which is one of the tasks of this section. With the proposed column configuration, the wash section is operated in a ‘once-through’ mode. Also with this configuration, entrained liquid by the gas will be removed. This will happen predominantly at the bottom of the wash section. Since the liquid from the bottom is not recycled to the top of the section, there is no impact on the absorption of solvent in the upper part of the wash section and the efficiency is not harmed. Therefore, no liquid separator is required in-between the absorption section and the wash section.

It is important that the gas stream from the carbon dioxide-absorption section is not cooled too fast; otherwise, the risk of aerosol formation is increased when using a conventional column configuration, according to US2003/0045756 i.e. when the gas with the low carbon dioxide concentration is fed to a cooling section directly. The reason for the increased aerosol formation risk is the higher solvent concentration in the flue gas leaving the carbon dioxide absorption section due to the increase flue gas temperature when using a selective packing. The above proposed column configuration helps to avoid the risk of aerosol formation in the wash section. The reason is as follows: the wash section is operated with a low liquid mass flow rate i.e. the condensate from the cooling section and optionally make-up water is low compared to the gas flow rate. Therefore, the temperature profile inside the wash section will be mainly determined by the gas temperature and the gas temperature will remain almost unchanged throughout the whole section. In this wash section the solvent concentration in the gas stream can be reduced to the required level and the water dew point will not change significantly. Hence, super-saturation of the solvent and water is avoided and as a consequence the risk of aerosol formation. The warm gas stream leaving the wash section enters the cooling section, where the gas stream is cooled and water is condensed. It cannot be avoided that the gas stream becomes super-saturated with water. However, should aerosols be formed, they are virtually free of solvent and consist mainly of water. Since water has a low molecular weight, mass transfer of water in the gas phase is relatively high and super-saturation is lower than for solvents with a concentration close to saturation.

The invention will be explained in more detail hereinafter with reference to drawings of exemplary embodiments:

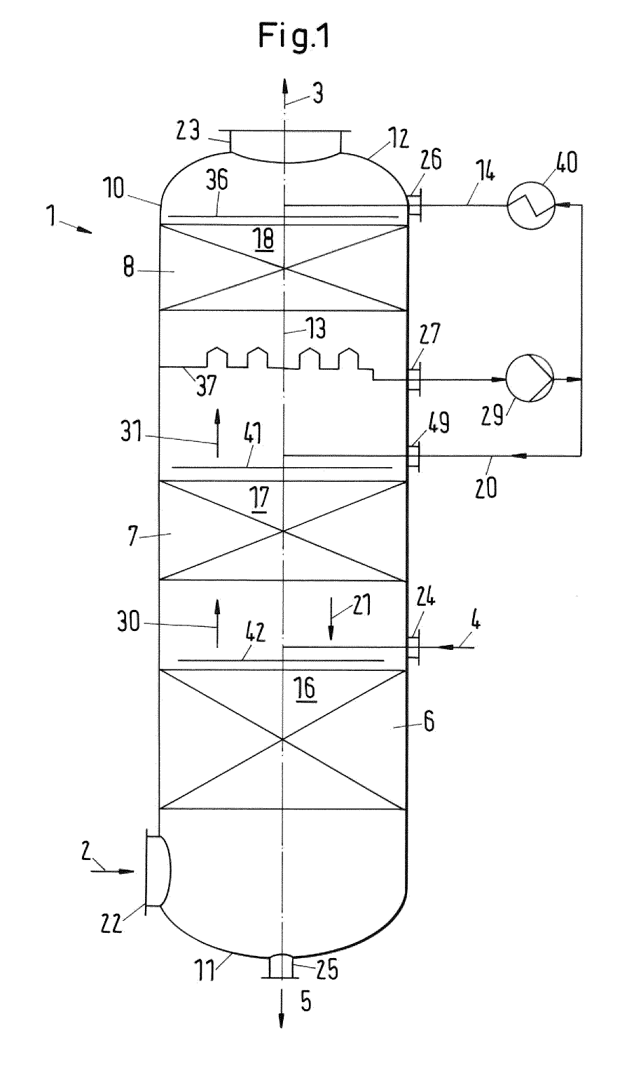

FIG. 1 shows an absorption apparatus according to a first embodiment of the invention,

FIG. 2 shows a temperature profile of the absorption section

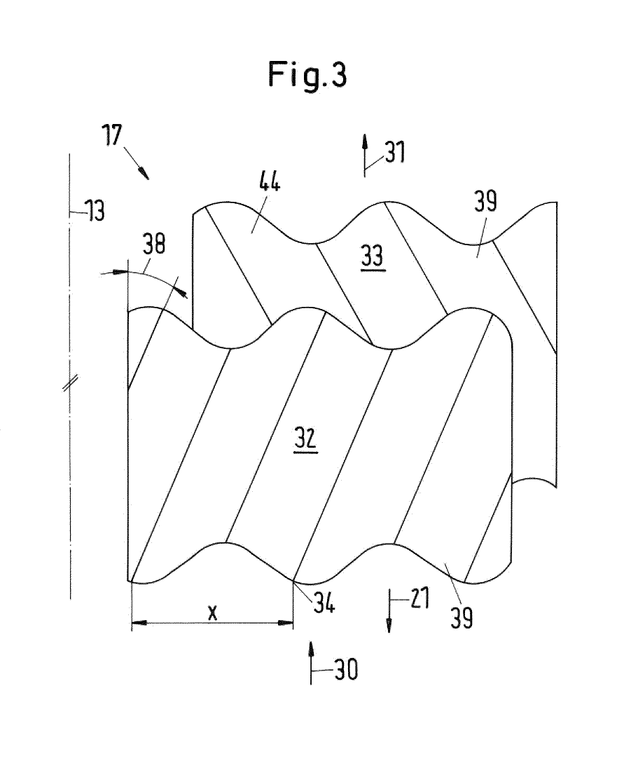

FIG. 3 shows a portion of a packing element including two layers arranged cross wise to another

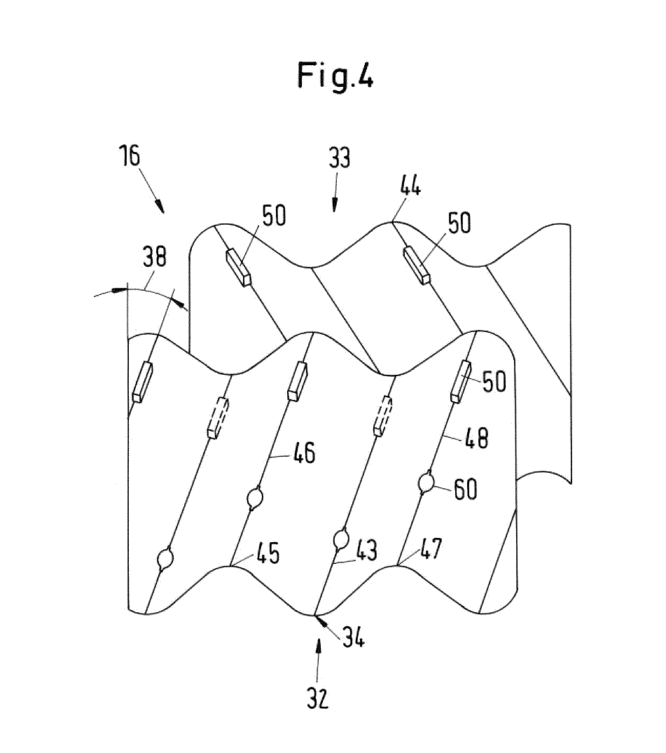

FIG. 4 shows a portion of a packing element including two layers arranged cross wise to another

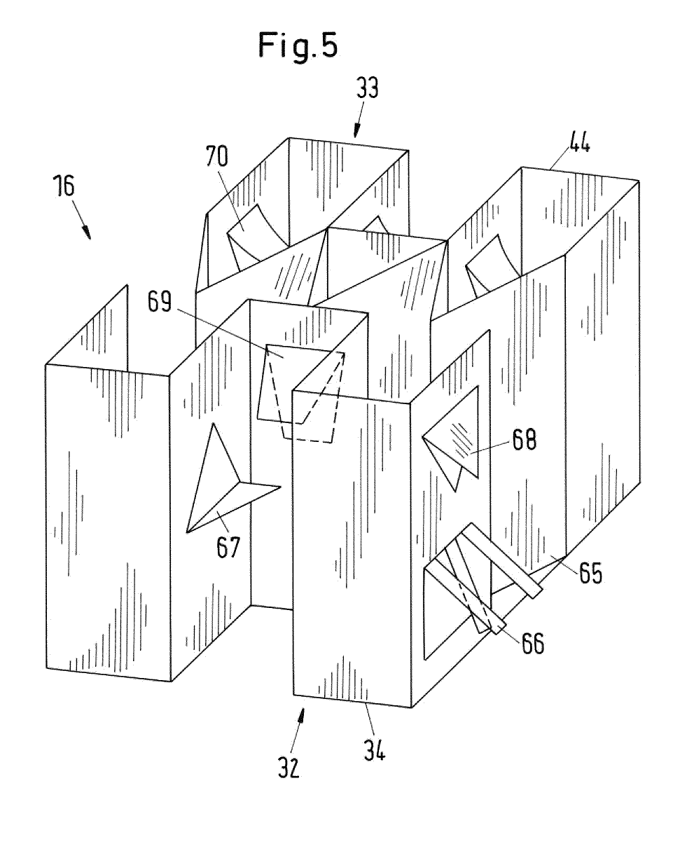

FIG. 5 shows a portion of a packing element including three layers arranged next to each other

FIG. 6 a schematic representation of resistances and fluxes for a conventional absorption packing at the top of a carbon dioxide absorption section

FIG. 7 a schematic representation of resistances and fluxes for a selective absorption packing at the top of a carbon dioxide absorption section

The absorption apparatus according to FIG. 1 is shown schematically sectional view. The absorption apparatus comprises mass transfer equipment with selectively reduced vapour side mass transfer efficiency for the carbon dioxide absorption section. The absorption apparatus 1 for the absorption of carbon dioxide from a carbon dioxide containing gas stream 2 includes a vessel 10. The gas stream 2 can have a temperature of 35° C. up to and including 70° C. The gas stream has a content of typically 4 to 15% carbon dioxide, whereby the percentage is a molar percentage. The vessel contains an carbon dioxide absorption section 6 containing a packing element 16 arranged between a bottom end 11 of the vessel 10 and a top end 12 of the vessel 10 using selective packing, at least partly. The vessel 10 has a main axis 13 extending from the bottom end 11 of the vessel 10 to the top end 12 of the vessel 10. Furthermore an inlet 22 for feeding the carbon dioxide containing gas stream 2 to the vessel 10 at the bottom end 11 and an outlet 23 for discharging a purified gas stream 3 at the top end 12 are provided. A solvent inlet 24 for adding a lean solvent 4 above the packing element 16 and a solvent outlet 25 for discharging rich solvent 5 from the vessel 10 at a location below the packing element 16 are provided. The solvent is provided in preferably at a temperature of 30° C. to 45° C. The packing element 16 is disposed with a plurality of layers made up of sheets wherein at least some of the sheets have corrugations. The corrugations 34, 44 have corrugation peaks forming crests and corrugation valleys forming troughs and the respective crests or troughs of the corrugations 34, 44 include an angle with the main axis which is less than 30 degrees. The height of the packing is advantageously in the range of 10 m to 30 m. Examples for such packing elements are shown in FIG. 3, FIG. 4 or FIG. 5. The plurality of layers can include at least a first layer 32 and a second layer 33, wherein the first layer is a first sheet having a first corrugation 34. The second layer 33 is a second sheet having a second corrugation 44. The first corrugation 34 includes an angle of corrugation greater than 0 degrees with the main axis 13 and the second layer is arranged cross wise to the first layer as shown in FIG. 3 or FIG. 4. The angle of corrugation is indicated by reference number 38.

The lean solvent 4 can be distributed by a lean solvent distribution element 42 onto the packing element 16. In an embodiment, the packing element 16 can have a configuration as shown in FIG. 3, 4 or 5.

According to FIG. 1 a wash section 7 is arranged in the vessel 10 between the top end 12 and the absorption section 6. The wash section 7 contains a packing element 17 and a water/liquid inlet 49 is arranged on top of the packing element 17. The height of the packing element 17 is in general not more than 6 m, in particular in a range of 2 to 6 m. Furthermore a distributor element 41 is arranged between the inlet 49 and the packing element 17. No liquid collector element is required below the packing element 17 and the liquid form the packing element 17 drips to the carbon dioxide absorption section 6. The packing element 17 of the wash section 7 is configured to provide an efficient solvent mass transfer from the gas stream of low carbon dioxide content 30 to the wash liquid 20. The wash liquid 20 is distributed by a wash liquid distribution element 41 onto the packing element 17. During the passage of the wash liquid along the sheets of the packing element 17, the wash liquid 20 is enriched with solvent entrained with the gas stream of low carbon dioxide content 30 from the absorption section 6. The solvent enriched wash liquid 21 can be used in the absorption section for the absorption of carbon dioxide in addition to the lean solvent added at inlet 24. A conventional structured packing element can be used, such as the packing element disclosed in EP 0858366 B1.

Above the wash section 7, a cooling section 8 is arranged in the vessel. The cooling section contains a packing element 18. The packing element 18 of the cooling section is advantageously of the shape as disclosed in EP 0858366 B1. A cooling fluid 14 enters the vessel at cooling fluid inlet 26 and is distributed by a cooling fluid distributor element 36 onto the packing element 18. The purified, substantially solvent free gas stream 31 enters the packing element in counter current flow to the cooling fluid 14. Condensed water from the gas stream is used as a cooling fluid. The cooling fluid 14 and additional water condensed from the flue gas is collected in a cooling fluid collector element 37 arranged beneath the packing element 18. The collector element is disposed with a reservoir from which an outlet 27 for the collected cooling fluid is foreseen. The cooling fluid is pumped by a cooling fluid pump 29 to a heat exchanger 40. From the heat exchanger 40, the cooling fluid is returned to the cooling fluid inlet 26. Due to the fact that water is condensed from the flue gas entering the cooling section 8, a portion of the withdrawn cooling fluid is branched and used as wash water in the wash section 7, so the recycled cooling fluid flow rate remains constant. Cooling fluid can be either branched from the warm cooling fluid before the heat exchanger 40 or from the cooled cooling fluid after the heat exchanger 40.

The operating pressure of the absorption apparatus is close to atmospheric pressure, preferably not more than 1.2 bar.

FIG. 2 shows a graphic of a temperature profile of the absorption section, that means the temperature distribution over the packing height. FIG. 2 is only a schematic representation, thus there are no values attached to the temperature as indicated on the x-axis of the graphic. There are also not attached any values to the packing height, which is indicated on the y-axis of the graphic. The lower end of the packing element is indicated as bottom of section 55. The upper end of the packing element is indicated as top of section 56. The continuous fat line 51 shows the temperature of the solvent, the dotted fat line 52 shows the temperature of the gas stream by making use of a selective packing element. The solid thin line 61 shows the temperature of the solvent, the dotted thin line 62 shows the temperature of the gas stream by making use of a conventional packing element. FIG. 2 thus shows that the temperature of the solvent and gas for a selective packing element is mostly lower over the entire height of the packing element. The advantage of the possibility to operate the absorption at the lower temperature is an increased possible carbon dioxide loading in the solvent. Thus aerosols form not at all or at least to a reduced extent apart from the advantage of reduced energy consumption, which contributes to increase the overall process economy.

The following temperatures have been indicated in FIG. 2: The temperature of the liquid 72 leaving the selective packing element on the upper end thereof, the temperature 73 of the carbon dioxide containing gas entering selective packing according to the invention as well as the temperature 74 of the gas leaving the selective packing. For comparison, the temperature of the liquid 76 leaving a conventional packing element, the temperature 77 of the carbon dioxide containing gas entering the conventional packing, which is the same as the temperature using selective packing as well as the temperature 78 of the gas leaving the conventional packing are indicated.

The temperature of the liquid 75 entering the conventional packing is the same as the temperature of the liquid 71 entering the selective packing.

The structured packing element 16 of the absorption section 6 in accordance with a preferred embodiment as shown in FIG. 3 has a layer 32, 33 being shaped as a sheet which has a wavelike corrugation, through which a plurality of open channels are formed which extend from the upper side of the packing to the bottom side of the packing, wherein the channels include a first wave trough, a first wave crest and a second wave crest. The first wave crest and the second wave crest bound the first wave trough. The first wave crest and the second wave crest have a first peak and a second peak. This structure is advantageously repeated periodically over the entire surface of each of the sheets of the packing element.

Advantageously the angle of corrugation 38 is not more than 30 degrees. The interstitial velocity can be decreased if the layers of the packing element are arranged in an angle of corrugation, which is not more than 30 degrees. The two packing layers of FIG. 3 are just shown as a matter of example, it goes without further notice, that a larger number of packing layers may be foreseen. Essentially the packing layers extend across the entire cross-sectional area of the vessel 10.

FIG. 4 shows an alternative configuration of a packing element which can advantageously be used as a packing element 16 in the absorption section 6. The packing element has selectively reduced vapour side mass transfer characteristics as disclosed in EP2230011 A1, WO2010/106011 A1, WO2010/106119, the contents of these applications being incorporated in its entirety by reference.

The packing element according to FIG. 4 comprises a first layer 32 having first corrugations 34 and a second layer 33 having second corrugations 44. A plurality of open channels is formed by the first corrugations and the second corrugations. The channels include a first corrugation valley 43, a first corrugation peak 45 and a second corrugation peak 47, wherein the first corrugation peak 45 and the second corrugation peak 47 bound the first corrugation valley 43. The first and the second corrugation peaks have a first apex 46 and a second apex 48. A protrusion 50 or an indentation 60 can extend in the direction of the first apex 46. In case a protrusion is provided the normal spacing of at least one point of the protrusion 50 from the valley bottom of the corrugation valley 43 is larger than the normal spacing of the first apex 46 from the first valley bottom of the corrugation peak 45. In case an indentation 60 is provided the normal spacing of at least one point of the indentation 60 from the valley bottom of the corrugation valley 43 is smaller than the normal spacing of the first apex 46 from the first valley bottom of the corrugation peak 45.

The packing element 16 can have neither indentations, nor protrusions. In this case the corrugation angle is less than 30 degrees. Alternatively it can have one of indentations 60 or protrusions 50 or it can have indentations 50 as well as protrusions 50. In this case the corrugation angle can be also greater than 30 degrees, thus may be in a range of up to 70 degrees. Due to the indentations or protrusions present on at least each second packing layer the pressure drop of the packing is reduced as compared to a packing element having packing layers devoid of any of an indentation or a protrusion.

The second layer 33 has second corrugations 44. The first layer 32 and the second layer 33 are arranged such that the channels of the first layer 32 cross the channels of the second layer 33. The first layer 32 is in touching contact with the second layer 33 by the protrusions 50 if foreseen or by the corrugation peaks of the first layer 32 crossing the corrugation valleys of the second layer 33. Alternatively if indentations are foreseen, then the touching contact is interrupted in each of the indentations 60, which is also shown in FIG. 4. Each of the layers can have at least one of a protrusion or an indentation or also only each first or each second layer of a plurality of layers can have at least one of such protrusions or indentations.

FIG. 5 shows a variant of a packing element, which includes a corrugation angle of 0 degrees with the main axis of the vessel 10. Only the differences to the packing elements with respect to the previous figures will be noted. The first and second layers 32, 33 of this packing element are separated by an intermediate layer 65. The first and second layers have tooth shaped first and second corrugations 34, 44, but they could equally have a wave shape as shown in the preceding embodiments. In order to increase mass transfer, the flow of the ascending carbon dioxide containing gas stream, or the gas stream of low carbon content or the washed purified gas stream is disturbed by deflector elements 66, 67, 68, 69, 70. Thereby the mass transfer between the gas stream and the corresponding liquid stream descending along the surface of the packing layer is increased.

The deflector elements 66, 67, 68, 69, 70 can be cut out of the layer and deflected at an angle towards the surface of the packing layer.

1-11. (canceled)

12. A method of performing a carbon dioxide absorption from a carbon dioxide containing stream in an absorption apparatus with reduced risk of aerosol formation, wherein the absorption apparatus comprises the following sections in sequence listed from bottom to top of a vessel of the apparatus:
at least one carbon dioxide absorption section
a “once through” wash section
a cooling section
wherein no liquid separator is located between the carbon dioxide absorption section and the wash section,
and wherein the method comprises the steps of:
(i) passing the carbon dioxide containing gas stream through a carbon dioxide absorption section to form a purified gas stream containing solvent and reduced in carbon dioxide content by means of absorbing the carbon dioxide using a solvent,
(ii) passing the purified gas stream through a “once through” wash section, which is operated with water condensate from a cooling section above the “once through” wash section and optionally with make-up water, to form a purified and washed gas stream having a reduced solvent content,
(iii) feeding the purified and washed gas stream into a cooling section to cool the purified and washed gas stream and to condense water to form a water condensate,
(iv) withdrawing the water condensate from the cooling section,
(v) recirculating (pumping around) a part of the withdrawn water condensate back into the cooling section,
(vi) feeding a remaining part of the withdrawn water condensate to the wash section, and wherein either all of or only a recirculated part of the water condensate withdrawn from the cooling section in step (iv) is cooled.

13. The method of claim 12, wherein no liquid collector is located between the carbon dioxide absorption section and the wash section.

14. The method of claim 12, wherein a cooled, purified, and washed gas stream produced by the method contains aerosol droplets, wherein the aerosol droplets are virtually free of solvent and consist mainly of water.

15. The method of claim 12, wherein the carbon dioxide-absorption section has a selective mass transfer equipment characterized by a poor vapour side heat and mass transfer.

16. The method of claim 15, wherein the mass transfer equipment characterized by a poor vapour side heat and mass transfer is a structured packing consisting of corrugated sheets having a corrugation angle of less than 30 degrees from the column axis.

17. The method of claim 16, wherein the structured packing consists of corrugated sheets, the corrugated sheets having a corrugation angle of less than 25 degrees from the column axis.

18. The method of claim 15, wherein the mass transfer equipment characterized by a poor vapour side heat and mass transfer is a structured packing having a first layer having first corrugations, a second layer having second corrugations, a plurality of open channels formed by the first corrugations and the second corrugations, wherein the channels include a first corrugation valley, a first corrugation peak and a second corrugation peak, wherein the first corrugation peak and the second corrugation peak bound the first corrugation valley, wherein the first and the second corrugation peaks have a first apex and a second apex, wherein a protrusion or an indentation extends in the direction of the first apex, wherein if a protrusion is provided the normal spacing of at least one point of the protrusion from the valley bottom of the corrugation valley is larger than the normal spacing of the first apex from the first valley bottom of the corrugation peak, and wherein if an indentation is provided the normal spacing of at least one point of the indentation from the valley bottom of the corrugation valley is smaller than the normal spacing of the first apex from the first valley bottom of the corrugation peak.

19. The method of claim 12, wherein the solvent is an aqueous solution selected from the group comprising an amine, an amine acid and a volatile compound which reacts with carbon dioxide.

20. A use of a structured packing as part of a carbon dioxide absorption section in an apparatus for the absorption of carbon dioxide, wherein the structured packing is selected from one of:
(a) a structured packing consisting of corrugated sheets having a corrugation angle of less than 30 degrees from the column axis; and
(b) a structured packing having a first layer having first corrugations, a second layer having second corrugations, a plurality of open channels formed by the first corrugations and the second corrugations, wherein the channels include a first corrugation valley, a first corrugation peak and a second corrugation peak, wherein the first corrugation peak and the second corrugation peak bound the first corrugation valley, wherein the first and the second corrugation peaks have a first apex and a second apex, wherein a protrusion or an indentation extends in the direction of the first apex, wherein if a protrusion is provided the normal spacing of at least one point of the protrusion from the valley bottom of the corrugation valley is larger than the normal spacing of the first apex from the first valley bottom of the corrugation peak, and wherein if an indentation is provided the normal spacing of at least one point of the indentation from the valley bottom of the corrugation valley is smaller than the normal spacing of the first apex from the first valley bottom of the corrugation peak,
wherein the use is in reducing the risk of aerosol formation in a top region of the carbon dioxide-absorption section.

21. The use according to claim 20, wherein the structured packing consists of corrugated sheets, the corrugated sheets having a corrugation angle of less than 25 degrees from the column axis.

22. The use according to claim 22, wherein the use is additionally in increasing a maximum carbon dioxide loading in a bottom region of the carbon dioxide absorption section.

23. A use of an absorption apparatus comprising the following sections in sequence listed from bottom to top of a vessel of the apparatus:
at least one carbon dioxide absorption section
a wash section
a cooling section
wherein no liquid separator is located between the carbon dioxide absorption section and the wash section, and wherein the use is for avoiding a super-saturation of a solvent and water and a risk of aerosol formation.

24. The use of claim 23, wherein the carbon dioxide-absorption section has a selective mass transfer equipment characterized by a poor vapour side heat and mass transfer.

25. The use of claim 24, wherein the mass transfer equipment characterized by a poor vapour side heat and mass transfer is a structured packing, wherein the structured packing consists of corrugated sheets having a corrugation angle of less than 30 degrees from the column axis.

26. The use of claim 24, wherein the structured packing consists of corrugated sheets, the corrugated sheets having a corrugation angle of less than 25 degrees from the column axis.

27. The use of claim 24, wherein the mass transfer equipment characterized by a poor vapour side heat and mass transfer is a structured packing having a first layer having first corrugations, a second layer having second corrugations, a plurality of open channels formed by the first corrugations and the second corrugations, wherein the channels include a first corrugation valley, a first corrugation peak and a second corrugation peak, wherein the first corrugation peak and the second corrugation peak bound the first corrugation valley, wherein the first and the second corrugation peaks have a first apex and a second apex, wherein a protrusion or an indentation extends in the direction of the first apex, wherein if a protrusion is provided the normal spacing of at least one point of the protrusion from the valley bottom of the corrugation valley is larger than the normal spacing of the first apex from the first valley bottom of the corrugation peak, and wherein if an indentation is provided the normal spacing of at least one point of the indentation from the valley bottom of the corrugation valley is smaller than the normal spacing of the first apex from the first valley bottom of the corrugation peak.
